(19) United States
(12) Patent Application Publication
(10) Pub. No.: US 2013/0159188 A1
(43) Pub. Date: Jun. 20, 2013

(54) AUTOMATIC USER VALIDATION SYSTEM AND METHOD

(71) Applicant: Charles A. Andon, Nashua, NH (US)

(72) Inventor: Charles A. Andon, Nashua, NH (US)

(73) Assignee: SaySearch Inc., Nashua, NH (US)

(21) Appl. No.: 13/717,623

(22) Filed: Dec. 17, 2012

Related U.S. Application Data
(60) Provisional application No. 61/576,718, filed on Dec. 16, 2011.

(51) Int. Cl. G06Q 20/40

(52) U.S. Cl. CPC G06Q 20/4014
USPC 705/44

(57) ABSTRACT

Methods and apparatus support optional user authentication. Whether an authentication, or an enhanced type of authentication, is required before proceeding with a transaction can be determined on a user-by-user basis. Some credit card users subscribe to a service that provides the users with security tokens. Transactions involving these credit cards may require correct entry of a security token code, before the transactions are allowed to proceed. However, other credit card users, i.e., users who have not subscribed to the service, are not required to enter a security token code before their transactions are allowed to proceed.

This application claims the benefit of priority to U.S. provisional application 61/576,718 filed Dec. 16, 2011 which is hereby incorporated by reference.

### TECHNICAL FIELD

The present invention relates to systems and methods for automatically validating users of credit cards, computer systems, online accounts, customer service organizations and the like and, more particularly, to such validations in situations in which some, but not necessarily all, legitimate users employ secondary identification mechanisms.

### BACKGROUND ART

Identity theft poses serious problems. Over 10 million adults were victims of identity theft in 2010, amounting to about $48 billion of fraud. Lost or stolen wallets, checkbooks and credit or debit cards make up about 43 percent of all identity theft incidents in which the “method of access” was known. Fear of credit and debit card fraud is very high among Americans, exceeding fear of terrorism, computer and health viruses and personal safety, according to a 2009 Unisys Security Index.

Various methods and systems have been developed in efforts to reduce identity theft. Most of these systems and methods involve techniques for determining if a person is who he or she claims to be. Known approaches for authenticating humans rely on at least one of three approaches, namely requiring: “something you know” (ex., a password or an answer to a predetermined question), “something you have” (ex., a security token) or “something you are” (ex., a fingerprint or a retina pattern).

A security token is a device that displays a code, typically a six-digit number, that changes with passage of time according to a secret “seed” value and an algorithm that is difficult to decipher. The displayed code typically changes every few seconds, thus observing or intercepting a successful transaction is not likely to provide sufficient information to enable an imposter to reuse a displayed code. A security token that is implemented as a dedicated hardware device is typically referred to as a “hardware token.” RSA, The Security Division of EMC, 174 Middlesex Turnpike, Bedford, Mass. 01730, provides exemplary hardware security tokens under the trade name SecurID.

Alternatively, a security token may be implemented in software that is executed on a general purpose processor, such as a processor in a mobile communication device. Such a security token is typically referred to as a “software token.” Software tokens are also available from RSA, The Security Division of EMC, under the trade name RSA SecurID Software Token. For simplicity of explanation, hardware and software tokens are collectively referred to herein as “security tokens.”

A system that requires entry of a security token code typically stores the seed values and algorithms of authorized users' security tokens in a database. When a purported user attempts to conduct a transaction with such a system, the system uses the seed value and the algorithm to calculate the code that the authorized user's security token should currently display and challenges the purported user to enter the code displayed by the security token. If the user-entered value matches the calculated value, the system assumes the user possesses the security token, or the user is at least in near real-time communication with someone who possesses the security token, and therefore the user is authorized.

“Two-factor authentication” (TFA, T-FA or 2FA) is an approach to authentication that requires presentation of two different kinds of evidence that a person is who she claims to be. TFA is a part of a broader family of multi-factor authentication (MFA), which is a defense-in-depth approach to security. From a security perspective, the underlying theory involves use of evidences that have separate ranges of attack vectors (ex., logical and physical), leading to more complex attack scenarios and, lower risk. For example, a typical TFA system requires entry of a passcode and entry of a displayed security token value.

On-line and in-person credit card transactions routinely require entry of TFA information. For example, a typical credit card transaction requires entry of a credit card account number (to identify the purported user), as well as the credit card's expiration date and a card verification value (CVV) code printed on the reverse side of the credit card (to verify authenticity of the purported user). Because the CVV is printed, but not embossed, on credit cards, transaction slips imprinted using credit cards do not contain the CVV. Expiration dates are embossed, thus transaction slips contain expiration dates. Thus, if an attack vector used to obtain a credit card number and expiration date involves obtaining transaction slips or copies thereof, a different attack vector would be required to obtain the corresponding CVV. Some merchants require credit card users to also display additional identification credentials, such as drivers' licenses with picture identifications, before completing in-person credit card transactions.

Innovative Card Technologies, Los Angeles, Calif. (InCard) developed a credit card (trade name DisplayCard) with an integrated security token.

MasterCard, 2000 Purchase Street, Purchase, N.Y. 10577, developed a SecureCode system that enables subscribing credit card users to select a passcode. When a credit card user accesses an on-line merchant system that participates in the SecureCode program, an in-line window appears to prompt for the user's passcode. However, when the credit card user access an on-line merchant system that does not participate in the SecureCode program, no such in-line window appears, and the user is not prompted for the passcode.

American Bank Incorporated (AmericanBank), 4029 West Tilghman Street, Allentown, Pa. 18104 provides on-line banking services, such as obtaining account balances, transferring funds between accounts and paying bills. In addition to a username and a passcode, each user is required to select either an answer to a secret question (essentially, a second passcode) or a security token. Before being permitted to conduct an on-line banking transaction, a user must enter her username, passcode and second passcode or security token code (as the case may be). In the case of a second passcode, after the user has entered her username and passcode on a first screen, the on-line banking system displays a second screen to prompt for entry of the second passcode. In the case of a security token, the user enters the security token code, concatenated with the password, in the password field of the first screen, and no second screen is displayed. Thus, AmericanBank utilizes TFA in their on-line banking system.

Although some banks and merchants may require multiple user authorizations (MFAs), such as entry of a passcode and entry of a security token code, per transaction, not all credit cards are equipped with built-in security tokens or are distributed with associated stand-alone security tokens. Some users may prefer the additional security provided by MFAs beyond expiration date and CVV, even if their credit card providers do not support such additional security measures. Other users may feel the additional complexity of MFA transactions is not justified.

### BRIEF DESCRIPTION OF THE DRAWINGS

The invention will be more fully understood by referring to the following Detailed Description of Specific Embodiments in conjunction with the Drawings, of which:

FIG. 1 is a schematic block diagram of components of a system for handling credit card transactions, according to the prior art.

FIG. 2 is a schematic block diagram of an environment in which systems for handling credit card transactions may be practiced, according to embodiments of the present invention.

FIG. 3 is a schematic block diagram of at least a portion of a record in a database of FIG. 2, according to an embodiment of the present invention.

FIG. 4 is a schematic diagram of an exemplary user interface provided by a merchant system of FIG. 2, according to an embodiment of the present invention.

FIG. 5 is a schematic block diagram of an exemplary embodiment of an identification verification request message of FIG. 2, according to an embodiment of the present invention.

FIG. 6 is a schematic block diagram of an exemplary embodiment of an identification verification response message of FIG. 2, according to an embodiment of the present invention.

FIG. 7 is a schematic block diagram of another environment in which systems for handling credit card transactions may be practiced, according to embodiments of the present invention.

FIG. 8 is a block diagram of an embodiment of an augmented credit card authorization system, according to an embodiment of the present invention.

FIG. 9 is a block diagram of an enhanced credit card authorization system, according to an embodiment of the present invention.

### DETAILED DESCRIPTION OF SPECIFIC EMBODIMENTS

In accordance with embodiments of the present invention, methods and apparatus are disclosed for supporting optional user authentication. That is, whether an authentication, or an enhanced type of authentication, is required before proceeding with a transaction can be determined on a user-by-user basis. In some embodiments, some credit card users subscribe to a service that provides the users with security tokens. Transactions involving these credit cards may require correct entry or transmittal of a security token code, before the transactions are allowed to proceed, and they may first require activation of the security token by biometrics (e.g. a fingerprint swipe; a retinal scan), or activation by a series of one or more graphical algorithms (e.g., correct identification by the user of an image known only to the user within a collage of random images; correct identification by the user of one or more sections of an image known only to the user within a larger image; correct identification by the user of a signature or watermark known only to the user within an image or dynamic presentation of said watermarks and images). Thus, these users may feel their credit cards are less subject to fraud than credit cards not subscribed to the service. However, other credit card users, i.e., users who have not subscribed to the service, are not required to enter a security token code before their transactions are allowed to proceed. Merchants may, therefore, give preferential treatment, such as discounts, to credit card users who subscribe to the service.

Similar methods and apparatus may be used for other types of financial transactions (such as automatic teller machine (ATM) transactions), as well as non-financial transactions, such as gaining access to computer systems (logging on), obtaining customer support services (such as may be provided to users who have paid for real-time or priority telephone support) and unlocking physical locks (so as to gain entry to secured facilities).

In accordance with some embodiments of the present invention, methods and apparatus enable a merchant, credit card provider or other provider to support a user base, a portion of which utilizes an enhanced authentication mechanism (such as security tokens), while the remained of the user base does not utilize the enhanced authentication mechanism. For example, a credit card provider that wishes to implement an enhanced authentication mechanism typically cannot do so instantly. That is, it may take time (such as hours, days, weeks, months or longer) to switch over from handling credit card transactions without any enhanced user authentication to handling some or all credit card transactions with such authentication. For example, it may take time to replace or reprogram servers that authorize credit card transactions, so these servers use the enhanced authentication information. Furthermore, it may take time to distribute security tokens to credit card users or to replace the users' credit cards with credit cards having built-in security tokens and for the users to begin using the tokens or replacement credit cards.

Some, but not all, of the users might use the enhanced authentication mechanism, while other of the user might use their credit cards without an enhanced authentication mechanism, at least for a period of time. Embodiments of the present invention may handle both types of transactions, i.e., transactions that do not include enhanced authentication information, as well as transactions that include such information, during a transition to full implementation or full adoption of the enhanced authentication scheme.

These and other embodiments will now be described in detail. For simplicity of description, credit cards, charge cards (which require any balance to be paid in full at the end of each billing cycle), cash cards (used for conducting ATM transactions), debit cards and the like are all collectively referred to herein as credit cards. Also for simplicity, purchases and refunds are collectively referred to herein as purchases or purchase transactions.

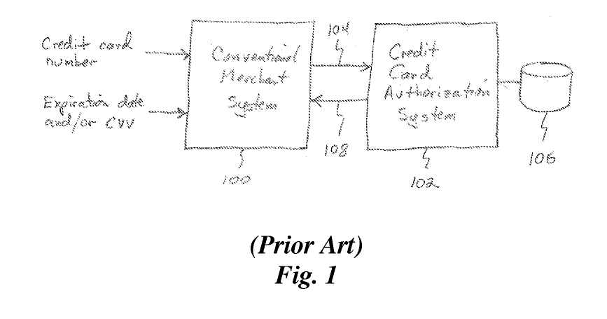

FIG. 1 is a schematic block diagram of components of a prior art system for handling credit card transactions. A merchant system 100 may be a point-of-sale (POS) terminal, a kiosk, an e-commerce web site or the like. To initiate a credit card transaction, such as a purchase, the merchant system 100 accepts a credit card number and the corresponding credit card's expiration date and/or the credit card's card verification value (CVV). In the case of a point-of-sale terminal, a credit card user (purchaser) or a merchant may swipe the credit card through a credit card reader to automatically read the credit card number, expiration date and/or CVV, for example as encoded on a magnetic stripe on the reverse side of the credit card. In other cases, the user or, more likely the merchant, manually keys in the credit card number, expiration date and/or CVV. Note that this information may be entered into the merchant system 100 later than an actual purchase, such as in a case where impressions of credit cards are taken during purchases, but the impressions are processed in a batch at the end of a business day.

The merchant system 100 communicates via an appropriate network, such as the Internet or via a dial-up telephone connection, to a credit card authorization system 102 operated by an acquirer or acquiring bank, as is well known in the art. The merchant system 100 sends information 104, such as the credit card account number, expiration date, CVV, transaction amount and transaction type (ex., purchase or refund), to the credit card authorization system 102. The credit card authorization system 102 queries a database 106 (possibly maintained by an issuer of the credit card) that contains a list of valid credit card account numbers and corresponding credit limits. If the user's credit card account number appears in the database 106 as a valid account, and the user's credit limit is sufficient to support the proposed transaction, the credit card authorization system 102 adjusts the credit limit (i.e., reserves an appropriate amount of the user's credit limit) based on the transaction amount and sends an approval message 108 to the merchant system 100. Otherwise, the credit card authorization system 102 sends a message 108 disapproving the transaction to the merchant system 100. Eventually, the issuer is debited, and the acquirer is credited, and the acquirer credits the merchant, less a discount rate, all as is well known in the art. For simplicity of explanation, I collectively refer to this process as “causing funds to be transferred,” and I refer to the credit card authorization system 102 as causing funds to be transferred, in relation to the transaction and the user account.

### Separate User Identity Verification System

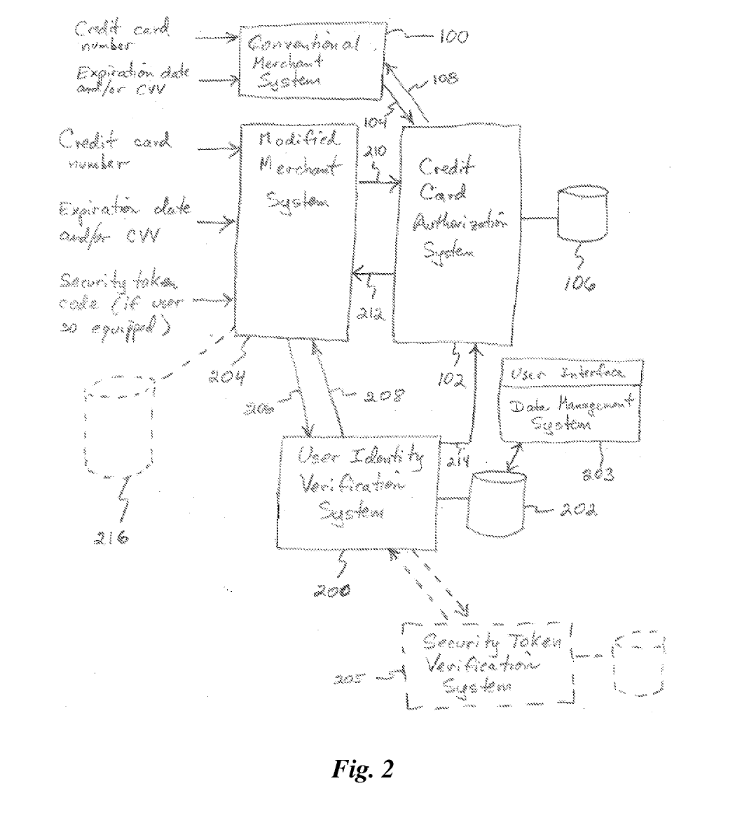

FIG. 2 is a schematic block diagram of an environment in which illustrative embodiments of the present invention may be practiced. The credit card authorization system 102 and its associated database 106 are the same as in the prior art (FIG. 1). However, in the environment shown in FIG. 2, some or all credit card users have subscribed to a service that provides the subscribers with security tokens to be used in conjunction with the users' credit cards. This service may be provided by an organization associated with the credit cards, such as a credit card issuer. Optionally or alternatively, the service may be provided by a third party that is not associated with the credit cards. Optionally or alternatively, the subscribers' credit cards may be replaced by credit cards that include security tokens. Optionally or alternatively, the subscribers may register security tokens the subscribers already possess for other purposes, rather than obtaining new security tokens or security-token-equipped credit cards. Thus, a single security token may be used for several purposes, such as accessing a computer system via a conventional log-on procedure, as well as protecting one or more credit cards, as described herein.

The subscribing users register their credit cards with a user verification system 200, which associates the registered credit cards with the users' security tokens. Thereafter, transactions involving these credit cards require entry of the codes displayed by the associated security tokens, at least for transactions conducted with merchants who also subscribe to the service. Transactions conducted with a non-subscribing merchant, such as the conventional merchant system 100 described above, do not require entry of the security token code and are handled as describe above, with respect to FIG. 1.

A modified merchant system 204 that subscribes to the identification verification service accepts input of a credit card number and may accept an expiration date and/or a CVV, as in the merchant system 100 of FIG. 1. The modified merchant system 204 may be a point-of-sale (POS) terminal, a kiosk, an e-commerce web site or the like. However, unlike the merchant system 100 of FIG. 1, the modified merchant system 204 also allows for input of a security code from the credit card user's security token, if the user has a security token. However, the modified merchant system 204 does not require input of a security token code, such as from non-subscribers. In this embodiment, the modified merchant system 200 cannot distinguish between subscribed and non-subscribed credit cards. Thus, the modified merchant system 200 allows, but does not require, input of the security token code.

The modified merchant system 204 communicates with a user identity verification system 200 to verify users who subscribe to the service, as describe in detail below. The modified merchant system 204 also communicates with the credit card authorization system 102, as in the prior art. As noted, in this embodiment, the modified merchant system 204 has no a priori information upon which to distinguish subscribed credit cards or subscribed users from non-subscribed credit cards or non-subscribed users. Thus, the modified merchant system 204 interacts with two verification/authorization systems 200 and 102 for each transaction, regardless of whether the transaction involves a subscriber or a non-subscriber. In other words, the modified merchant system 204 always seeks identity verification from the user identity verification system 200, even if no security token code was entered.

As described in more detail below, in this embodiment, if the user identity verification system 200 does not recognize the credit card or user (i.e., the credit card or user is not subscribed to the service), the user identity verification system 200 nevertheless returns a positive indicator, thus permitting the modified merchant system 204 to continue processing the transaction, despite no security token code having been entered. However, if the credit card or user is subscribed to the service, the user identity verification system 200 returns a positive indicator only if a correct security token code has been entered. Thus, the modified merchant system 204 does not need to distinguish between subscribed and non-subscribed credit cards or users. The modified merchant system 204 simply queries the user identity verification system 200 for all credit card transactions. Furthermore, the credit card authorization system 102 and the interactions between the modified merchant system 204 and the credit card authorization system 102 need not be modified from the prior art.

The user identity verification system 200 verifies the identities of subscribed users, and the system 200 assumes all non-subscribed users are valid, leaving the credit card authorization system 102 to perform its checks. The enhanced user identity verification provided by the user identity verification system 200 is optional, in that the enhanced user identity verification is provided only for subscribers. That is, whether an enhanced authentication is required is determined on a user-by-user basis. The user identity verification system 200 is distinct from the credit card authorization system 102. The user identity verification system 200 verifies identity of a user, but it does not cause funds to be transferred.

It should be noted that, in some embodiments, although entry of the security token code (user verification data) is optional, this description and the associated claims are distinct from, and not intended to cover, a conventional username-and-password-protected system, such as a convention computer log-on. In such a conventional system, a user may intentionally or unintentionally omit entering a password. However, such conventional systems do not decide whether a password is required, based on an entered username.

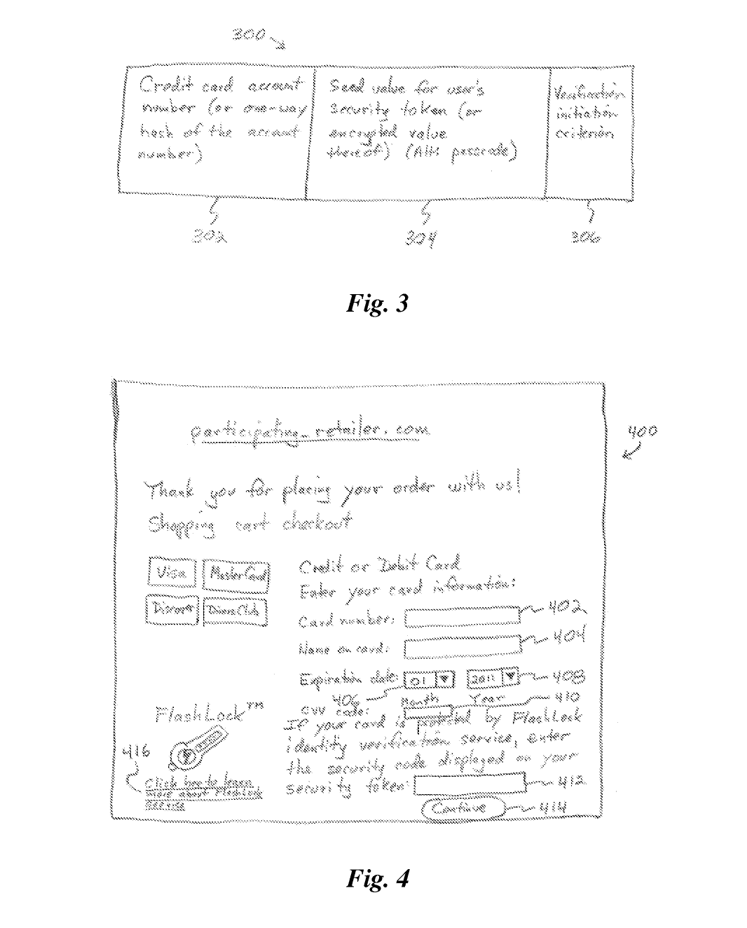

The user verification system 200 is coupled to a database 202, which stores information associating the subscribed credit cards with security tokens. Data may be entered and modified in the database 202 through a manual or an automatic data management system 203. FIG. 3 is a schematic block diagram of at least a portion of a record 300 in the database 202. The record 300 includes two portions 302 and 304, which collectively associate a credit card account with a security token. Each record of the database 202 therefore corresponds to a respective user who, or a credit card that, is authorized to conduct a predetermined type of transaction, in this case, transactions involving the user's credit card. In other embodiments, other types of transactions may be financial or non-financial transactions, as discussed above.

In one embodiment, the first portion 302 of the record 300 includes the account number associated with the credit card or, preferably, a one-way hashed (encrypted) version of the account number. Optionally or alternatively, the first portion 302 may include a user name or other user-unique identifier of the user of the credit card. Thus, as used herein, a user identifier may be a username, a credit card account number or another user-unique identifier.

The contents of the first portion 302 are preferably encrypted, preferably before the contents are provided to the user verification system 200, so the user verification system 200 does not store, ideally not even temporarily, an unencrypted version of the credit card account number or other user identifier. Avoiding storing this unencrypted information in the user verification system 200 prevents creating a potential cyber-attack target, because a one-way hashed version of the credit card account number would be of no value to an imposter.

The second portion 304 of the record 300 includes a seed value, preferably encrypted, of the security token and/or other information, such as an algorithm, needed to automatically calculate a value that is expected to be displayed by the security token. If the security tokens are provided by the subscription service, the seed values, algorithms, etc. are known to the service and may be manually or automatically added to the database 202, such as via the data management system 203. However, if a user uses an existing security token, the seed value, etc. may need to be obtained from the original issuer of the security token. This information may be electronically obtained from an appropriate security token system, such as via an appropriate computer network. Optionally or alternatively, the second portion 304 of the record 300 includes a pointer, such as a URL, or other information that enables the user verification system 200 to communicate with an external security token code checker 205.

Returning to FIG. 2, the modified merchant system 204 accepts input of a credit card number and an expiration date and/or a CVV, similar to the merchant system 100 of FIG. 1. However, unlike the merchant system 100 of FIG. 1, the modified merchant system 204 also allows for input of a security code from the credit card user's security token. As noted, not all credit card customers of the merchant necessarily have security tokens. Therefore, a user interface provided by the modified merchant system 204 allows for, but does not require, entry of a security token code.

FIG. 4 is a schematic diagram of an exemplary user interface 400 provided by the merchant system 204. The user interface 400 is a web-based user interface displayed using a conventional browser. However, other types of user interfaces may be used. For example, the user interface may be implemented with purpose-built computer software or dedicated keys and a display or indicator lights. The user interface 400 shown in FIG. 4 includes fields for entering a credit card number 402, a name of the credit card user 404, expiration date of the credit card 406 and 408, CVV code 410 and security token code 412. Some embodiments include fields for both expiration date 406 and 408 and CVV code 410, whereas other embodiments include only some or none of these fields.

Optionally, other fields (not shown), such as user's billing address, may also be included. Optionally, the user interface 400 includes a hyperlink 416 that, when invoked, causes display of a web page that includes information about the user verification service and solicits users and merchants to subscribe to the service. Optionally or alternatively, the user interface 400 may include a field for a username or other user identifier (not shown), in addition to or in place of the credit card number field 402.

Once the fields 402-410 and, optionally, field 412 have been filled in, activating a “Continue” button 414 causes the merchant system 204 to read and process the field contents. The person who provided the credit card account number is referred to herein as a “purported user,” at least until the purported user's identity has been verified.

Returning again to FIG. 2, after the modified merchant system 204 receives a credit card account number and possibly a security token code (and optionally credit card expiration date, CVV code, etc.) from the user interface 400, the modified merchant system 204 sends an identification verification request message 206 to the user identity verification system 200. The message 206 essentially requests the user identity verification system 200 to attempt to verify the identity of the purported user.

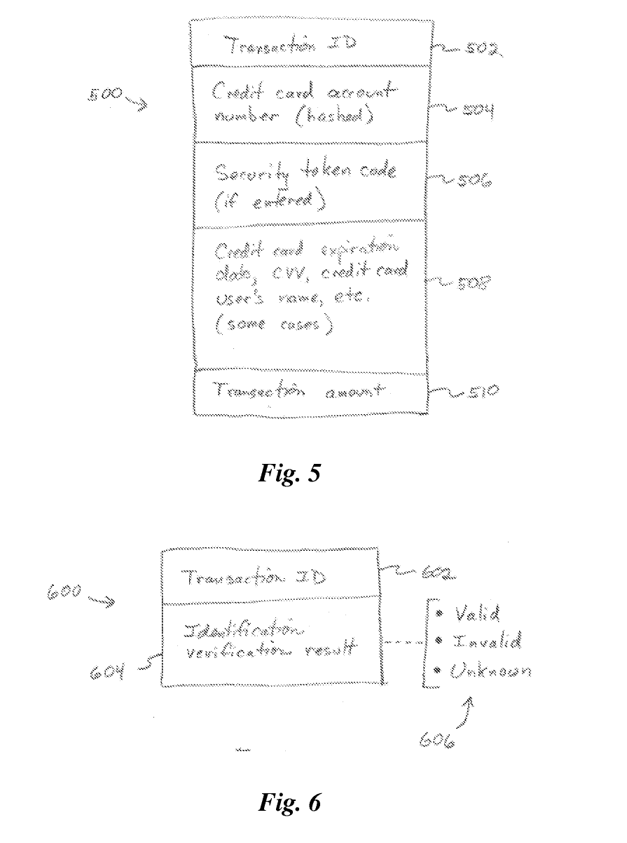

FIG. 5 is a schematic block diagram of an exemplary embodiment 500 of the message 206. The message 500 may include a transaction identification field 502. The modified merchant system 204 may sequentially number the messages 206 it sends, using the transaction identification field 502, so the user verification system 200 can use identical or corresponding transaction identifications when it responds.

The message 500 includes the credit card account number (preferably one-way hashed) 504 or another value (such as a user name) that the purported user provided to identify herself. The modified merchant system 204 preferably encrypts (such as with a one-way hash) this information to protect this information while the message 206 is in transit. Furthermore, preferably, the user's credit card account number or other identifier is stored as an encrypted value by the user identity verification system 200, as discussed above.

A security token code field 506 contains the security token code provided by the purported user, if the user provided such a code. This field 506 may also be encrypted. As noted, some legitimate credit card users do not have security tokens. Thus, merely because the purported user does not provide a security token code does not necessarily indicate the purported user is an imposter.

The message 500 may also include one or more additional fields, such as field 508, to store a credit card expiration date, CVV, credit card user's name, etc. Other fields (not shown) may be included in the message 500, as needed or desired.

Returning to FIG. 2, after the user verification system 200 receives the message 206, the user verification system 200 queries the database 202 for a record that contains the credit card account number or other user identifier contained in field 502 of the message 206. If such a record is found, the user identity verification system 200 compares the security token code in the message 206 to information in the found record. The user verification system 200 sends an identification verification response message 208 back to the merchant system 204 indicating a result of the verification check.

FIG. 6 is a schematic block diagram of an exemplary embodiment 600 of the identification verification response message 208. The message 600 may include a transaction identification field 602. The user identity verification system 200 may copy the contents of the transaction identifier field 502 of the identification verification request message 206 into the transaction identification field 602 of the identification verification response message 600, so the merchant system 204 can correlate response messages 208 with earlier-sent request messages 206. The user identity verification system 200 might not necessarily send the identification verification response messages 208 in the same order as it receives the identification verification request messages 206. Furthermore, several identification verification request messages 206 might be simultaneously outstanding, i.e., without corresponding responses having yet been sent by the user identity verification system 200. The user identity verification system 200 may be implemented as a server, and it may serve several modified merchant systems (only one shown) and/or other types of clients, as discussed in more detail below.

An identification verification result field 604 of the identification verification response message 600 may include a code to indicate whether the identity of the purported user was verified by the user identity verification system 200. In this embodiment, one of two possible values is returned in the identification verification result field 604, namely either “Valid” or “Invalid.” (Other equivalent terms, such as “Verified” and “Not verified,” may be used.)

As noted, the user verification system 200 queries the database 202 for a record that contains the credit card account number or other user identifier contained in field 502 of the identification verification request message 206. As noted, these values may be encrypted. Furthermore, values derived from the credit card account number or user identifier or encrypted versions thereof may be used in the identification verification request message 206 and/or in the database 202. Therefore, I refer to this database query as checking if the database contains a record storing a user identifier equivalent to the received identifier of the purported user.

If such a record is found, the user identity verification system 200 compares the security token code (field 506) in the message 206 to information in the second portion 304 of the found record. This may involve using the seed value, algorithm and/or other information stored in the second portion 304 of the record to calculate an expected security code displayed by the corresponding security token. The user identity verification system 200 compares this calculated value to the value passed in the security token code field 506 of the identification verification request message 206. Alternatively, the user identity verification system 200 communicates with an external server 205, which performs an equivalent comparison. In either case, I refer to this comparison as checking if the received data purportedly verifying the identity of the purported user corresponds with the identity verification information stored in the record, and I refer to the identity verification information stored in the record as being configured to enable verification of a code automatically generated by a security token.

If the values match, the user identity verification system 200 sets the value of the identification verification result field 604 of the identification verification result message 208 to “Valid.” If the values do not match, the value of the identification verification result field 604 is set to “Invalid.”

However, if the query of the database 202 for a record that contains the credit card account number or other user identifier contained in field 502 of the identification verification request message 206 fails, that is, if the database 202 does not contain a record storing a user identifier equivalent to the received identifier (field 502) of the purported user, therefore indicating the purported user is not subscribed to the user identity verification system 200, the user identity verification system 200 sets the value of the identification verification result field 604 of the identification verification result message 208 to “Valid,” and the identification verification result message 208 is sent to the modified merchant system 204. (“Valid” is equivalent to “verified.”)

It is counterintuitive to indicate the purported user is verified under these circumstances. Conventional authorization systems return an indicator of “not verified” when a purported user is not found in a database of authorized users. However, in this embodiment, the user verification system 200 returns an indicator of “Valid,” because the purported user has not subscribed to the verification system, as indicated by absence of the purported user's credit card or other identification information in the database 202. The user verification system 200 has no basis on which to conclude the purported user is an imposter.

The user identity verification system 200 provides enhanced user identity verification for subscribed users or subscribed credit cards. In other words, the verification performed by the user identity verification system 200 is in addition to any verification performed by the credit card authorization system 102. Even if the user identity verification system 200 finds the purported user valid, the credit card authorization system 102 may deny the transaction, such as if the user's credit limit is insufficient or the credit card has been reported stolen. Similarly, if the user or credit card is not subscribed, the user identity verification system 200 has no basis on which to prevent the transaction from proceeding, but the credit card authorization system 102 may deny the transaction.

If the identification verification result message 208 contains “Valid” in the identification verification result field 604, the modified merchant system 204 allows the transaction to proceed. For example, the modified merchant system 204 may then communicate 210 and 212 with the credit card authorization system 102, as in the prior art. However, if the identification verification result field 604 contains “Invalid,” the modified merchant system 204 prevents the transaction from proceeding. For example, the modified merchant system 204 may decline the transaction. Optionally, the modified merchant system 204 may send a message 214 to the credit card authorization system 102 indicating that the user's credit card account may have been compromised.

It is important to note that, in this embodiment, the merchant system 204 sends an identity verification request message 206 each time a credit card transaction is initiated, regardless of whether a security token code was entered or not entered in the security token field 412 (FIG. 4). Thus, if an imposter attempts to use a subscribed credit card without the credit card user's permission, the imposter will not have the credit card user's security token and, therefore, will not be able to enter a correct security token code, and the user identity verification system 200 will detect the attempted identity theft/fraud.

Optionally or alternatively, the modified merchant system 204 may include a database (shown in dashed line at 216 in FIG. 2) that identifies credit card accounts or users who are subscribed to the user identity verification service. In this case, the modified merchant system 204 may automatically determine which purported users or credit cards need to be verified by the user identity verification system 200. For purported users or credit cards that are subscribed to the service, the modified merchant system 204 sends messages 206, as described above. However, for credit cards or users who are not listed in the database 216, the modified merchant system omits sending the messages 206. Instead, the modified merchant system 204 just seeks authorization from the credit card authorization system 102.

The database 202 used by the user identity verification system 200 may be part of the user identity verification system 200. Optionally or alternatively, all or part of the database 202 may be implemented as a separate database coupled to a single computer or set of computers that implement the user identity verification system 200. Optionally or alternatively, all or part of the database 202 may be remote from the single computer or set of computers that implement the user identity verification system 200. As noted, the user verification system 200 may communicate with an external security token verification system 205, such as a system operated by a security token service provider, such as RSA, The Security Division of EMC.

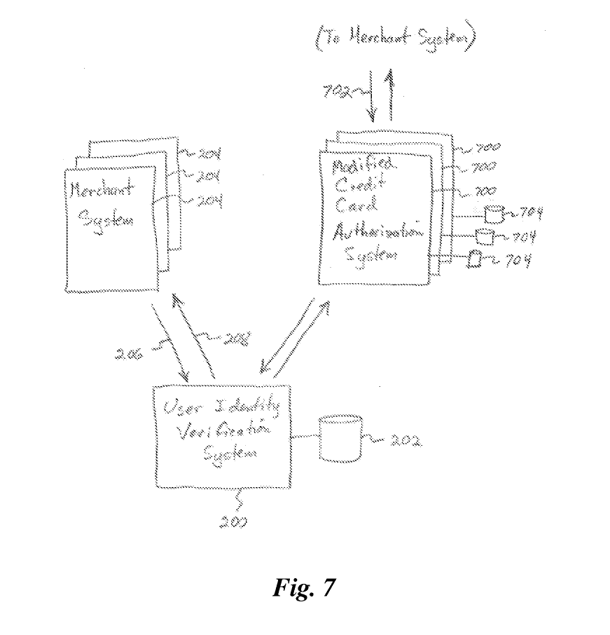

As noted, the user identity verification system 200 may be implemented as a server, and it may serve several modified merchant systems and/or other types of clients. FIG. 7 is an exemplary schematic block diagram illustrating an environment in which embodiments of the present invention may be practiced. One user identity verification system 200 may serve several modified merchant systems 204.

The user identity verification system 200 may serve one or more modified credit card authorization systems 700. Each modified credit card authorization system 700 may send a message similar to message 206 (FIG. 2) to the user identity verification system 200 whenever the modified credit card authorization system 700 receives a credit card authorization request 702 or, alternatively, when the modified credit card authorization system 700 receives a credit card authorization request 702 related to a credit card that is subscribed to this service. For each credit card account, the credit card authorization system 700 may include in its database 704 an indication of whether the credit card is subscribed to the service.

### Other Forms of Identity Verification Information

The above-described embodiments use security token generated codes to verify identities of purported users. Optionally or alternatively, other forms of information may be used to verify the identity of the purported user. For example, in an embodiment of the present invention, a passcode (or a hash thereof) is stored in the second portion 304 (FIG. 3) of the record 300 of the database 202, and the purported user may be asked for the passcode, instead of a security token code. In other words, the passcode is used as a substitute for a security token code. In other respects, this embodiment's operation is similar to the embodiment described above, although I believe this embodiment provides less security than the above-described embodiment, because the passcode is relatively static, whereas the security token code is automatically changed every few seconds.

### Tri-Output User Identity Verification System

Yet another embodiment is similar to the embodiment described above, with respect to FIGS. 2-6, except the user identity verification system 200 returns one of three distinct possible values in the identification verification result field 604 (FIG. 6), namely either “Valid,” “Invalid” or “Unknown,” as shown at 606. In this embodiment, the user identity verification system 200 (FIG. 2) queries the database 202 for a record that contains the credit card account number or other user identifier contained in field 502 (FIG. 5) of the identification verification request message 206, as described above.

If such a record is found, the user identity verification system 200 compares the security token code (field 506) in the message 206 to information in the second portion 304 of the found record, as described above. If the values match, the user identity verification system 200 sets the value of the identification verification result field 604 of the identification verification result message 208 to “Valid.” If the values do not match, the value of the identification verification result field 604 is set to “Invalid.” However, if the query of the database 202 for a record that contains the credit card account number or other user identifier contained in field 502 of the identification verification request message 206 fails, that is, if the database 202 does not contain a record storing a user identifier equivalent to the received identifier (field 502) of the purported user, therefore indicating the purported user is not subscribed to the user identity verification system 200, the user identity verification system 200 sets the value of the identification verification result field 604 of the identification verification result message 208 to “Unknown.”

It should be noted that “Unknown” is different than “Invalid.” “Invalid” means the user identity verification system 200 positively determined that the user identity verification information passed in field 506 of the identity verification request message 206 is incorrect for the purported user identity indicated by the credit card account number field 504. On the other hand, “Unknown” means the user identity verification system 200 does not have information about the purported user indicated by the credit card account number field 504.

No known user identity verification system returns one of three values, including “Unknown” if the purported user is not listed in an associated database.

Some embodiments require the identification verification request message 206 to include a security token code (field 506) in the message 206. Some embodiments allow, but do not require, the identification verification request message 206 to include a security token code (field 506) in the message 206. In other words, data purportedly verifying identity of the purported user may be required by some embodiments, whereas other embodiments make the data purportedly verifying identity of the purported user optional. In either of these embodiments, if the user identity verification system 200 (FIG. 2) finds a record in the database 202 that contains the credit card account number or other user identifier contained in field 502 (FIG. 5) of the identification verification request message 206, but the security token code (field 506) in the message 206 is empty or absent, the user identity verification system 200 sets the value of the identification verification result field 604 of the identification verification result message 208 to “Invalid.” In other words, the user identity verification system 200 sends a message 208 that indicates the purported user is not valid if the database 202 contains a record storing a user identifier equivalent to the received identifier of the purported user, but the received request 206 contains no data purportedly verifying identity of the purported user.

A modified merchant system that communicates with such a tri-output user identity verification system may be configured to allow a transaction to proceed, if the response from the user identity verification system indicates verification of the user is “Unknown.”

The message formats described above, with respect to FIGS. 5 and 6, define a communication protocol that may be used between a modified merchant system and a user identity verification system or between a modified credit card authorization system and a user identity verification system.

### Augmented Credit Card Authorization System

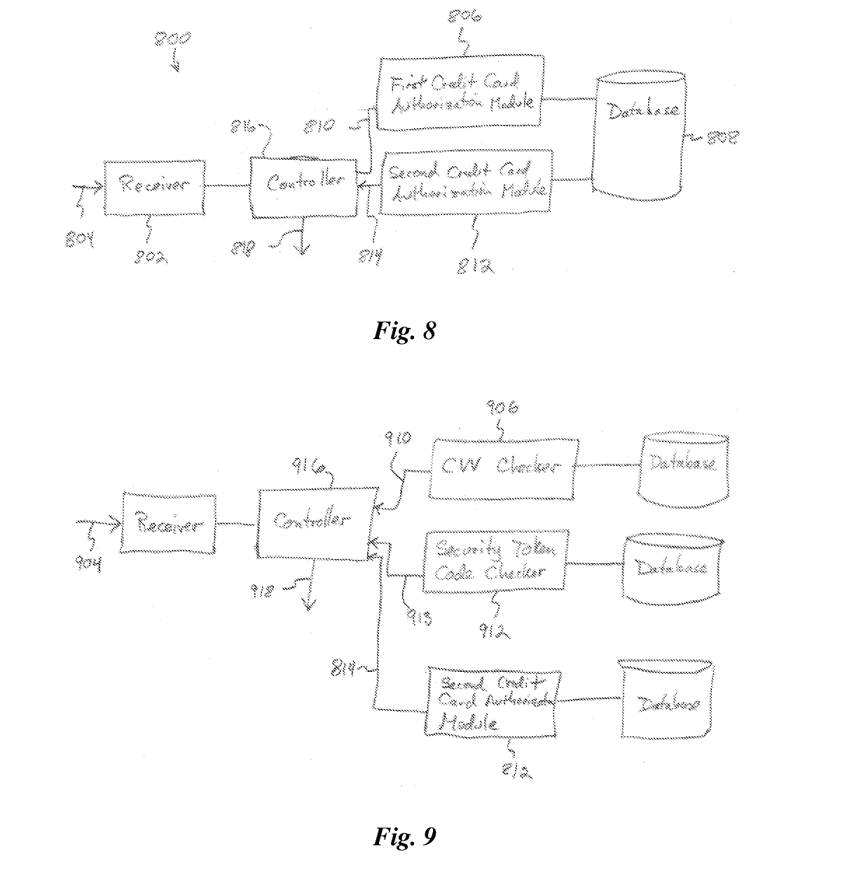

A credit card authorization system may include functionality of a conventional credit card authorization system 102 (FIG. 1) and functionality of the user identification verification system 200 (FIG. 2). I refer to such an authorization system as an augmented credit card authorization system. A block diagram of one embodiment of an augmented credit card authorization system 800 is shown in FIG. 8. A receiver 802 is configured to receive credit card transaction authorization requests 804, as in the prior art, except each credit card transaction authorization request 804 includes a transaction amount, a purported credit card account identifier and optional data purportedly providing enhanced user identity verification.

A first credit card account verification module 806 performs functions similar to functions performed by the user identity verification system 200 (FIG. 2). The first credit card account verification module 806 access a database 808 to determine whether the purported credit card account identifier of the credit card transaction authorization requests 804 requires enhanced user identity verification. If the purported credit card account identifier does not require enhanced user identity verification, the first credit card account verification module 806 outputs an approval 810. For example, if the purported credit card account identifier is not listed in the database 808 as requiring enhanced user identity verification, the first credit card account verification module 806 outputs the approval 810.

The database 808 is configured to store identification verification information, other than a credit card account identifier, for each credit card account identifier for which enhanced user identity verification is required. For example, as discussed above with respect to FIG. 2, the identification verification information may be information related to a security token. If the purported credit card account identifier does require enhanced user identity verification, i.e., if the credit card is subscribed to the service, the first credit card account verification module 806 compares a security token code included in the credit card transaction authorization request 804 to the information in the database 808, as described above. It should be noted that the credit card transaction authorization request 804 may include one or more messages and may involve an exchange of messages between the augmented credit card authorization system 800 and the merchant or other system making the credit card authorization request 804.

The first credit card account verification module 806 is configured to output an approval 810 if the received purported credit card account identifier is represented in the database 808, and the received data purportedly providing enhanced user identity verification corresponds with the identification verification information stored in the database 808.

A second credit card account verification module 812 is configured to output an approval 814 if the received purported credit card account identifier is valid, i.e., if the purported user's credit card account number appears in the database 808 as a valid account, and the user's credit limit supports the proposed transaction. Other checks, such as checks for unusual spending activity, reported lost or compromised credit card accounts, etc., may be performed, as are well known in the art.

The receiver 802 and the two credit card authorization modules 806 and 812 are coupled to a controller 816. The controller 816 receives the approvals 810 and 814. If both the first and the second credit card account verification modules 806 and 812 output approvals 810 and 814, the controller 816 authorizes 818 the received credit card transaction authorization request 804. In addition, the user's credit limit is adjusted, as discussed above.

Another embodiment of an enhanced credit card authorization system 900 is shown schematically in FIG. 9. This embodiment is configured to require a purported user to enter a security token code or a CVV. In this embodiment, the credit card transaction authorization request 904 includes a purported credit card account identifier, such as a credit card account number, and either a CVV or a security token code. In this case, a CVV checker 906 is configured to output an approval 910 if the CVV in the credit card transaction authorization request 904 (if one is provided) is valid. If no CVV is provided in the credit card transaction authorization request 904, a security token checker 912 checks the security token code (or other data, such as a password or answer to a secret question, in the received credit card transaction authorization request 904 that purports to provide enhanced user identity verification), as described above, with respect to the first credit card authorization module 806. If the check of the security token code indicates an authorized user, the security token checker 912 outputs an approval 913.

A second credit card authorization module 812 operates as described above, with respect to FIG. 8.

If the second credit card authorization module 812 and at least one of the CVV checker 906 or the security token code checker 912 outputs approvals 814 and 910 or 913, a controller 916 approves the credit card transaction.

Optionally or alternatively, both the CVV and the security token code are required for the controller 916 to approve the credit card transaction.

### Transaction Amounts below a Predetermined Value or of a Predetermined Type

Optionally or alternatively, to streamline user interactions for transactions less than a predetermined amount, such as about $10, the modified merchant system 204 (FIG. 2), the modified credit card authorization system 700 (FIG. 7) or any other system that communicates with the user verification system 200 (FIG. 2) may do so only for transactions involving more than the predetermined transaction amount. The modified merchant system 204, the modified credit card authorization system 700, etc. may store a merchant-specified threshold value, or a threshold value specified by a credit card issuer, acquirer or other party. This value may be stored in the database 214 for the modified merchant system 204 or the database 704 for the credit card authorization system 700, for example. This threshold value may be compared to each transaction amount to determine if the transaction amount exceeds the predetermined value.

Optionally or alternatively, the modified merchant system 204 or the modified credit card authorization system 700 may send a transaction amount in a transaction amount field 510 of the message 500 (FIG. 5), and the user identity verification system 200 may be configured to return “valid” if the transaction amount is less than a predetermined value, without further checking whether the purported user is subscribed or not, and without checking whether the security token code field 506 contains a valid value.

Optionally or alternatively, only predefined types of transactions cause communication with the user verification system 200 or, alternatively, all transaction types other than the predefined types of transactions cause communication with the user verification system 200. Similarly, only predefined types of transactions may be checked by the user identity verification system 200 or, alternatively, all transaction types other than the predefined types of transactions may be checked by the user identity verification system 200. The database 214, 202 or 704 may store a criterion (or several criteria) (“verification initiation criterion”), by which a decision can be made by the modified merchant system 204, the modified credit card authorization system 700 or the user identity verification system 200, as to whether to check identity of a purported user who initiates a particular transaction. For example, the user identification verification system 200 may check the identity of the purported user only for a predetermined list of merchants, or for any merchant other than merchants included in a predetermined list. Similarly, purported user identity checks may be performed or dispensed with, based on the type of merchant or the type of goods or services involved. For example, gasoline, grocery and clothing purchases may be checked, whereas in-person payments to medical service providers may be dispensed with. The message 500 (FIG. 5) may be modified to include merchant identity, merchant type, good/service type, etc., as needed.

As used herein, a validation request is more than a request to see if a purported user exists, such as a query to a database of users, for example LinkedIn.com. As used herein, a validation request is for the purpose of determining if the purported user is authorized to conduct a transaction. A user identity verification system, a modified merchant system, a modified credit card authorization system and an augmented credit card authorization system, as described herein, may be implemented by a processor controlled by instructions stored in a memory. The memory may be random access memory (RAM), read-only memory (ROM), flash memory or any other memory, or combination thereof, suitable for storing control software or other instructions and data. Some of the functions performed by the systems described herein have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on tangible non-writable storage media (e.g. read-only memory devices within a computer, such as ROM, or devices readable by a computer I/O attachment, such as CD-ROM or DVD disks), information alterably stored on tangible writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of the systems have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiments.

What is claimed is:

1. An automatic user validation system for determining if a purported user may conduct a transaction, comprising:
a server configured to:
access a computerized database configured to store a plurality of records, wherein each record of the plurality of records corresponds to a respective user authorized to conduct a predetermined type of transaction and is configured to store a user identifier associated with the authorized user;
receive a user validation request, the request comprising an identifier of a purported user; and
send a message that indicates the purported user is valid, if the database does not contain a record storing a user identifier equivalent to the received identifier of the purported user.

2. A system according to claim 1, wherein:
each record of the plurality of records is further configured to store identification verification information, other than the user identifier, associated with each authorized user;
the user validation request further comprises data purportedly verifying identity of the purported user; and
the server is further configured to send a message that indicates the purported user is valid if:
the database contains a record storing a user identifier equivalent to the received identifier of the purported user, and
the received data purportedly verifying the identity of the purported user corresponds with the identity verification information stored in the record.

3. A system according to claim 2, wherein the server is further configured to send a message that indicates the purported user is invalid if:
the database contains a record storing a user identifier equivalent to the received identifier of the purported user, and
the received data purportedly verifying the identity of the purported user does not correspond with the identity verification information stored in the record.

4. A system according to claim 1, the system further comprising the database.

5. A system according to claim 2, the system further comprising the database.

6. A system according to claim 3, the system further comprising the database.

7. A system according to claim 3, wherein the identity verification information stored in the record is configured to enable verification of a passcode.

8. A system according to claim 3, wherein the identity verification information stored in the record is configured to enable verification of a code automatically generated by a security token.

9. A system according to claim 1, wherein the predetermined type of transaction comprises a financial transaction.

10. A system according to claim 1, wherein the predetermined type of transaction comprises a credit card transaction.

11. A system according to claim 1, wherein the predetermined type of transaction comprises accessing a computer.

12. A system according to claim 1, wherein the predetermined type of transaction comprises unlocking a lock.

13. A system according to claim 1, wherein the predetermined type of transaction comprises obtaining a service.

14. A system according to claim 1, wherein:
the user validation request comprises a transaction amount; and
the server is configured to send a message that indicates the purported user is valid, if the received transaction amount is less than a predetermined value.

15. A system according to claim 14, wherein:
each record of the plurality of records is configured to store a transaction amount threshold;
the server is configured to receive a value from an authorized user and to store the received value in the corresponding record as the transaction amount threshold; and
the server is configured to use the transaction amount threshold in the record as the predetermined value.

16. A system according to claim 1, wherein:
each record of the plurality of records is configured to store a verification initiation criterion; and
the server is configured to send a message that indicates the purported user is valid, if the verification initiation criterion is not satisfied.

17. An automatic user validation system for determining if a purported user may conduct a transaction, comprising:
a server configured to:
access a computerized database configured to store a plurality of records, wherein each record of the plurality of records corresponds to a respective user authorized to conduct a predetermined type of transaction and is configured to store a user identifier associated with the authorized user and identification verification information, other than the user identifier, associated with the authorized user;
receive a user validation request, the request comprising an identifier of a purported user and data purportedly verifying identity of the purported user; and
send a message that indicates the purported user is valid if:
the database contains a record storing a user identifier equivalent to the received identifier of the purported user, and
the received data purportedly verifying the identity of the purported user corresponds with the identity verification information stored in the record;
send a message that indicates the purported user is invalid, if:
the database contains a record storing a user identifier equivalent to the received identifier of the purported user, and
the received data purportedly verifying the identity of the purported user does not correspond with the identity verification information stored in the record; and
send a message that indicates validity of the purported user is unknown (wherein “unknown is distinct from “invalid”) if:
the database does not contain a record storing a user identifier equivalent to the received identifier of the purported user.

18. A system according claim 17, the system further comprising the database.

19. A system according to claim 17, wherein the identity verification information stored in the record is configured to enable verification of a passcode.

20. A system according to claim 17, wherein the identity verification information stored in the record is configured to enable verification of a code automatically generated by a security token.

21. A system according to claim 17, wherein:
wherein the user validation request further comprises one of: (a) data purportedly verifying identity of the purported user and (b) no data purportedly verifying identity of the purported user; and
the server is further configured to send a message that indicates the purported user is invalid if:
the database contains a record storing a user identifier equivalent to the received identifier of the purported user, and
the received request contains no data purportedly verifying identity of the purported user.

22. An automatic user validation system for determining if a purported user may conduct a transaction, comprising:
a server configured to:
access a computerized database configured to store a plurality of records, wherein each record of the plurality of records corresponds to a respective user authorized to conduct a predetermined type of transaction and is configured to store a user identifier associated with the authorized user;
receive a user validation request, the request comprising an identifier of a purported user; and
send a message that indicates validity of the purported user is unknown, if the database does not contain a record storing a user identifier equivalent to the received identifier of the purported user.

23. A system according to claim 22, wherein:
each record of the plurality of records is further configured to store identification verification information, other than the user identifier, associated with each authorized user;
the user validation request further comprises data purportedly verifying identity of the purported user; and
the server is further configured to send a message that indicates the purported user is valid if:
the database contains a record storing a user identifier equivalent to the received identifier of the purported user, and
the received data purportedly verifying the identity of the purported user corresponds with the identity verification information stored in the record.

24. A system according to claim 23, wherein the server is further configured to send a message that indicates the purported user is invalid, if:
the database contains a record storing a user identifier equivalent to the received identifier of the purported user, and
the received data purportedly verifying the identity of the purported user does not correspond with the identity verification information stored in the record.

25. A system for handling transactions involving respective users, the system comprising:
a computer comprising an interface configured to solicit, for each transaction, input of a user account identifier and user verification data, wherein entry of the user account identifier is required, but entry of the user verification data is optional, the computer being configured to:
communicate with a transaction authorization server to cause funds to be transferred, in relation to the transaction and the user account;
communicate with a user verification server, distinct from the transaction authorization server, to verify identity of a user, but not to cause funds to be transferred;
for each transaction, send the account identifier entered, and the user verification data, if entered, to the user verification server;
receive a response from the user verification server;
allow the transaction to proceed, if the response from the user verification server indicates the user is verified and a response from the transaction authorization server indicates the transaction is authorized; and
prevent the transaction from proceeding, if the response from the user verification server indicates the verification of the user failed.

26. A system according to claim 25, wherein:
each transaction has an associated transaction amount; and for each transaction, the computer is configured to:
send the account identifier, and the user verification data, if entered, to the user verification server, if the associated transaction amount exceeds a predetermined value; and
allow the transaction to proceed, if the associated transaction amount is no greater than the predetermined value and the response from the transaction authorization server indicates the transaction is authorized.

27. A system according to claim 25, further comprising:
a database coupled to the computer and configured to store identification of at least one merchant-entered transaction type; and wherein:
the computer is configured to determine whether to send the account identifier entered, and the user verification data, if entered, to the user verification server, based on a type of the transaction and the at least one merchant-entered transaction type stored in the database.

28. A system according to claim 25, wherein the user account identifier comprises a credit card account number.

29. A system according to claim 28, wherein the user verification data comprises an automatically-generated security token code.

30. A system according to claim 25, wherein the computer is configured to allow the transaction to proceed, if the response indicates verification of the user is unknown.
